(19) United States
(12) Patent Application Publication
(10) Pub. No.: US 2013/0237890 A1
(43) Pub. Date: Sep. 12, 2013

(54) MIGRAINE HEADACHE MITIGATION

(71) Applicants: Casey A. Dennis, Sequim, WA (US); Michael R. Dennis, St. Helens, OR (US)

(72) Inventors: Casey A. Dennis, Sequim, WA (US); Michael R. Dennis, St. Helens, OR (US)

(21) Appl. No.: 13/603,401

(22) Filed: Sep. 4, 2012

Related U.S. Application Data
(60) Provisional application No. 61/530,961, filed on Sep. 3, 2011.

(51) Int. Cl. A61H 1/00

(52) U.S. Cl. CPC A61H 1/006
USPC 601/151

(57) ABSTRACT

Apparatuses for reducing migraine headache pain comprising head-contacting expanses of compressible material having pressure-versus-deflection characteristics possessing plateau conditions defined by ranges of compressive material deflections associated throughout with substantially constant material compression produced by an applied, material-compressing pressure which is slightly less than that pressure which, when applied to the anatomy, occludes anatomical, venous-return blood flow, and shells substantially surrounding, and contacting, the compressible-material expanses, appropriately sized, and operable, with the apparatuses in place on a wearers' heads, to place the compressible material in the expanse in its characteristic “plateau” condition of compression, wherein such compression, at every location, is a non-adjustable value dependent entirely upon the fit-spacing at that location between a wearer's head and the inside of the shell. This disclosure additionally or alternatively discusses methods of reducing migraine headache pain by fitting apparatuses to wearers' heads for appropriate time expanses and other methods of reducing migraine pain.

### CROSS REFERENCE TO RELATED APPLICATIONS

This application claims filing-date priority to U.S. Provisional Patent Application Ser. No. 61/530,961, filed Sep. 3, 2011, for “MIGRAINE HEADACHE MITIGATION.” The entire disclosure this currently co-pending U.S. Provisional Patent Application is hereby incorporated herein by reference.

### BACKGROUND

This invention pertains to apparatus and an associated methodology for mitigating the pain of a migraine headache. In this sense, we refer to this invention as lying in the category of a non-medication analgesic approach to easing migraine pain.

Background information which is related to the present invention is presented in U.S. Regular patent application Ser. No. 12/657,570, Filed Jan. 21, 2010, for “Dynamic-Response, Anatomical Bandaging System and Methodology.” Other background information which may be related to the present invention is presented in U.S. patent application Ser. No. 12/960,493, Filed Dec. 4, 2010, for “ANATOMICAL, PRESSURE-EVENIZING MATTRESS OVERLY WITH PRESTRESSED CORE, AND BAFFLED, LATERAL-EDGE CORE RESPIRATION,” U.S. patent application Ser. No. 12/657,568, Filed Jan. 21, 2010, for “ANATOMICAL, PRESSURE-EVENIZING MATTRESS OVERLAY,” U.S. patent application Ser. No. 12/798,390, Filed Apr. 2, 2010, for “ANATOMICAL, PRESSURE-EVENIZING MATTRESS OVERLY AND ASSOCIATED METHODOLOGY,” and U.S. Pat. No. 6,803,005, Filed Nov. 14, 2001, for “METHOD FOR MAKING MULTI-LAYER, PERSONNEL-PROTECTIVE HELMET SHELL,” the entire disclosures of which are all hereby incorporated by reference.

### BRIEF DESCRIPTION OF THE DRAWINGS

FIG. 1 is a simplified, anatomy-side view of a layered, dynamic-response, anatomical bandaging expanse made in accordance with a preferred and best-mode embodiment of the present invention. Portions of this expanse have been broken away to reveal details of construction.

FIG. 2 is an enlarged, fragmentary view taken generally along the line 2-2 in FIG. 1.

FIG. 3 is a graph illustrating five curves describing the respective compressive-load versus compression-deflection behaviors of five different, dynamic-response, viscoelastic foam materials that are employable satisfactorily as a particular one of the layers in the bandaging expanse of FIGS. 1 and 2. The central curve in this figure illustrates this characteristic for the preferred viscoelastic foam material which is employed.

FIG. 4 is a simplified plan view of the bandaging-attaching face or side of what is referred to herein as an elongate, expanse-edge-attachable/removable, dynamically-responsive, wrap-closure tensioning (or bridging closure) structure which is employed to fix in place, and to introduce wrapping tension into the bandaging expanse illustrated in FIGS. 1 and 2. This tensioning structure is used under circumstances where the bandaging expanse is applied as an edge-overlap wrap around an anatomical limb, such as around the leg.

In FIG. 4, the illustrated tensioning structure is shown in solid lines in a nominal, un-stretched condition, and in dashed, and dash-dot, lines, respectively, in two, differently stretched conditions—that which is illustrated in dashed lines picturing a lesser stretch than that which is pictured in dash-dot lines. Double-arrow-headed dashed and dash-dot lines, respectively, help to illustrate these two stretches.

FIG. 5 is an edge view taken generally along the line 5-5 in FIG. 4. FIGS. 4 and 5 are drawn on about the same scale—one which is intermediate the scales employed in FIGS. 1 and 2.

FIG. 6 is a simplified view picturing the bandaging expanse of FIGS. 1 and 2 in an edge-overlap condition wrapped around a non-illustrated anatomical limb, and fixed in place, and put under appropriate tension, by a plurality (only one being shown) of tensioning structures like that shown in FIGS. 4 and 5. The bandaging expanse, and the single tensioning structure, shown in FIG. 6 are pictured, relative to one another, in a modestly exploded condition, with the two, single-headed, downwardly pointing arrows that appear in this figure representing hook-and-pile attachments between the opposite ends of the tensioning structure and the outer side, or surface, the wrapped expanse, and with slightly downwardly curved, double-headed arrow in this figure representing a tensed and stretched condition in the illustrated tensioning structure. FIG. 6 is drawn on approximately the same scale as that which is employed in FIG. 1.

FIG. 7, with certain illustration portions broken away to show details of construction, is a fragmentary, plan view of what is referred to herein as expanse-cooperative, dynamic-response, flexible splinting structure. FIG. 7 is drawn on about the same scale as that which is employed in FIG. 6.

FIG. 8 is a view taken generally along the line 8-8, in FIG. 7. The three, different types of components that are pictured in FIGS. 1-8, inclusive, collectively make up the dynamic-response bandaging system of the present invention in its preferred and best-mode forms.

FIGS. 9 and 10 are, respectively, lateral and rear, fragmentary views illustrating all of the several components which are pictured in FIGS. 1-8, inclusive, applied collaboratively to a person's left leg, ankle and foot. FIGS. 9 and 10 are drawn on a scale which is slightly smaller than that which is employed in FIGS. 6-8, inclusive. In these two figures, bandaging illustration and specific descriptive discussion below focus principally on bandaging which is provided for the leg.

FIG. 11 is a side elevation view of an example of an apparatus for reducing migraine headache pain, the apparatus including a shell and an expanse. A portion of the shell is cutaway to illustrate the expanse. A phantom line extends proximate the perimeter of the shell to illustrate the perimeter of the expanse within the shell.

FIG. 12 is a graph illustrating five curves describing the respective compressive-load versus compression-deflection behaviors of five different, dynamic-response, viscoelastic foam materials that are employable satisfactorily as expanses to be used. The central curve in this figure illustrates this characteristic for the preferred viscoelastic foam material which is employed.

In all of the structural-illustration drawing figures herein, individual components, and portions thereof, are not necessarily drawn to scale with respect to one another. In some instances, sizes have been exaggerated so that certain things could more readily be seen at the drawing scales selected for the drawings.

### DETAILED DESCRIPTION

The disclosed apparatuses and methods for migraine headache mitigation will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following

Throughout the following detailed description, examples of various apparatuses and methods for migraine headache mitigation are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

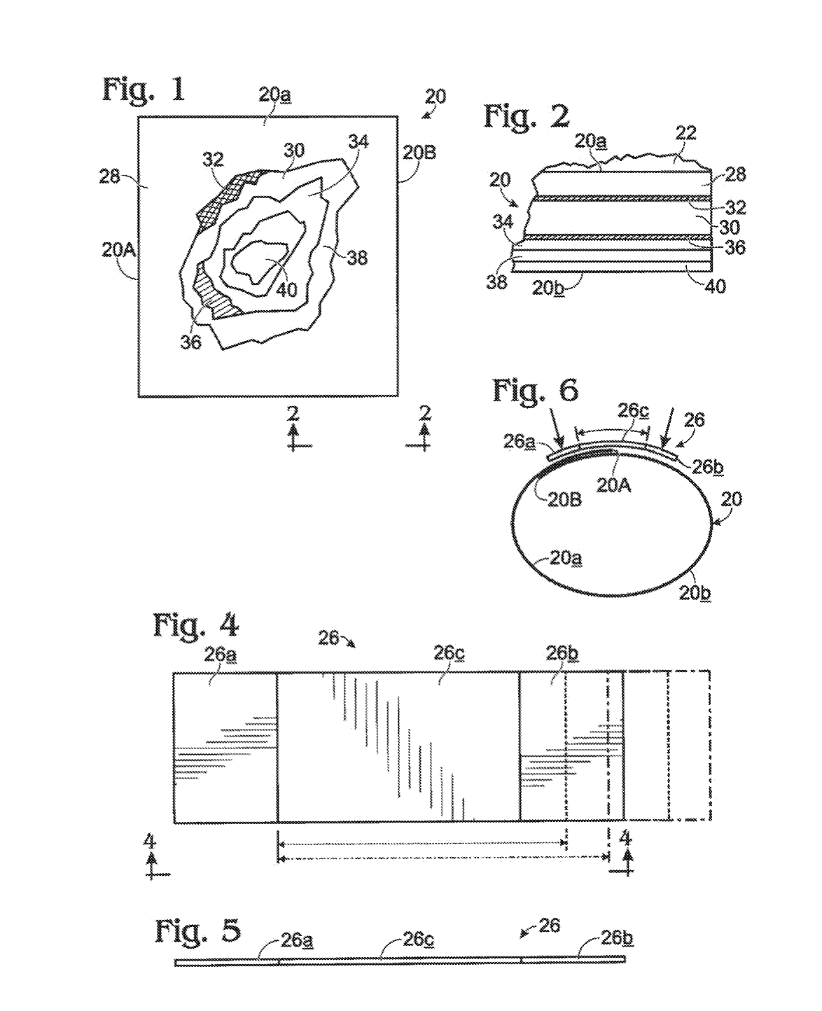

Turning now to the drawings, indicated generally in an isolated fashion at 20 in FIGS. 1 and 2 is what is referred to herein as a layered, dynamic-response anatomical bandaging expanse having an inner side 20a, which is applicable directly to, and in contact with, the human anatomy, a portion of which anatomy is shown fragmentarily at 22 in FIG. 2, and an outer side 20b. Expanse 20 further includes a pair of spaced, opposite edges 20A, 20B, and, as will further be explained, is deployable in tension as and overlapping-edge (20A, 20B) wrap extending around an anatomical limb (such as the leg), in the manner generally shown in a very simplified form in FIG. 6 for the expanse. In order for FIG. 6 to present this wrapped condition of expanse 20 in as simple and uncluttered a form as possible, no anatomical limb, per se, is illustrated in this figure.

Bandaging expanse 20 forms one of three main components, or elements, of a dynamic-response bandaging system which is made in accordance with the structure of the present invention, the two other main components, or elements, in which system taking the forms, respectively, of what are referred to herein as (a) an expanse-cooperative, dynamic-response, flexible splinting structure (singular-component, or composite plural-component), shown generally at 24 in FIGS. 7-10, inclusive, and (b), an elongate, expanse-edge-attachable/removable, dynamically responsive, wrap-closure tensioning structure 26, seen in FIGS. 4-6, inclusive, 9 and 10.

Bandaging expanse 20 herein is made up of five, joined, unified layers of different fabric and foam materials, and a pair of special, flexible, gas-permeable, moisture-resistant, non-latex adhesives. The five “fabric layers” include (1) a medical grade, tricot, moisture-wicking fabric layer 28 (also heat-, friction- and shear-minimizing against the skin) which has an upper, anatomy-facing side in FIG. 2 that forms the previously mentioned inner side of expanse 20, (2) a dynamic-response, low-rebound, acceleration-rate-sensitive, anatomical-pressure-applying, viscoelastic foam layer 30 whose dynamic-response, cushioning-compression characteristics that are important in the functionality of the present invention will be described shortly, and which is bonded to layer 28 through one of the just-above-mentioned adhesive layers shown at 32, (3) a gas-permeable, moisture-resistant, abrasion-inhibiting fabric layer 34 which is joined to layer 30 through the other, above-mentioned, adhesive layer, here shown at 36, (4) a polyurethane foam layer 38 which is joined to layer 34, and (5) a fabric layer 40 referred to herein as a pile-portion fabric layer which takes the form of the pile portion of conventional hook-and-pile connection fabric material, such as the material referred to as Velcro®. this layer being joined to layer 38. The underside of layer 40 in FIG. 2 forms the previously mentioned outer side of expanse 20.

Each of the several, bandaging-expanse layers/materials just described is individually conventional in construction, readily commercially available, and is hereinafter identified, in terms of specific, representative materials which we have preferred (others being usable as well), in the following manner. Moisture-wicking fabric layer 28, of which a number are generally known in the art is preferably the material identified as Orthowick™, made by Velcro USA, Manchester, N.H. The two, mentioned, flexible adhesive layers are alike, and preferably are formed of a glue made by Henkle, Inc, headquartered in Dusseldorf, Germany, and referred to as Imperial 1059 glue.

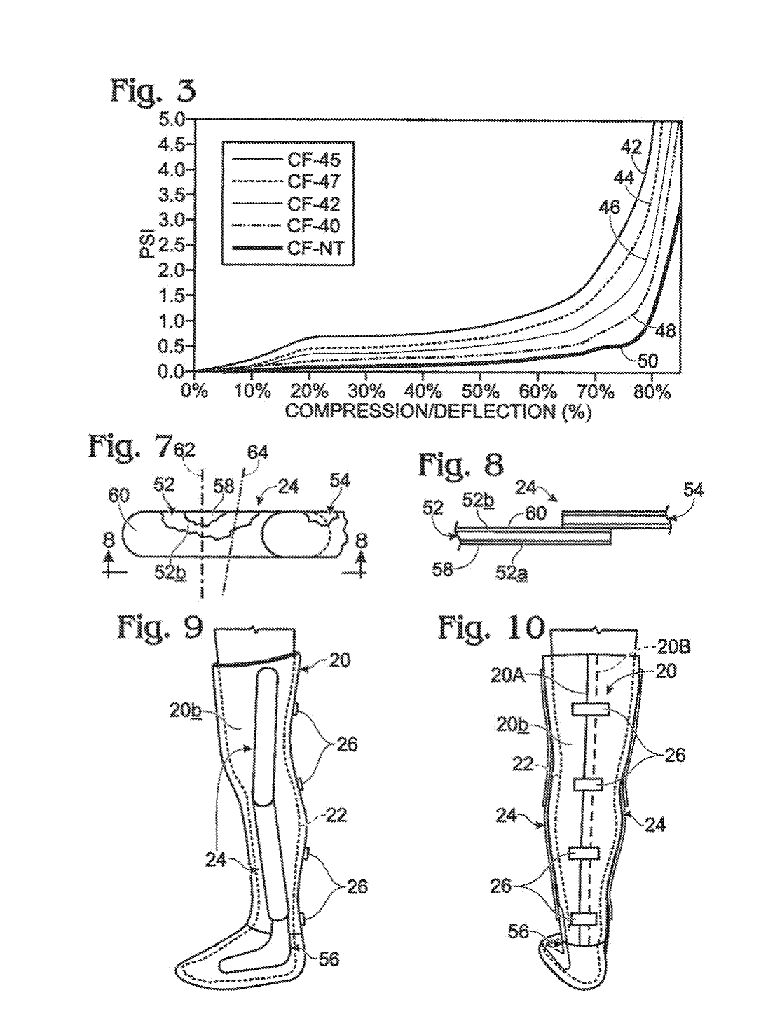

Dynamic-response foam layer 30 is formed of a temperature-, pressure-, and acceleration-rate-sensitive, cellular, viscoelastic foam material, and is preferably one of the several foam materials (CF-40, CF-42, CF-4S, CF-47, CF-NT) sold under the trademark Confor®, and made by EAR Specialty Composites in Indianapolis, Ind. This layer, for which we have particularly chosen Product No. CF-42, has a preferred thickness for the purpose of the present invention, of about 0.375-inches, and, as do all five of the just-mentioned Confor® products, has a very special, internal, dynamic-reaction characteristic which will be more fully described shortly, and which is illustrated by the central one of the five curves appearing in FIG. 3 in the drawings. Each of these material-characteristic curves exhibits a compressive-load versus compression-deflection behavior having a large, substantially linear, central region in which a major change in compressive deflection, occurring within a range of about from 20% to about 60% compressive deflection (or about 0.15-inches in the preferred, layer-30 material thickness mentioned above), relates to what one can think of as being an anatomically insignificant change in associated compressive load, typically lying, as can be seen, within a total range approximately centered on about, 0.5-pounds-per-square-inch. As has been mentioned earlier herein, the overall, operative, compressive range which characterizes layer 30 in bandaging expanse 20 more specifically is between about 0.3-psi to about 0.7-psi.

Layers 34, 38, 40 herein preferably form portions of a commercially available, single, integrated material having an overall thickness of about 0.125-inches, and sold as the product referred to as Veltex®, made by Velcro USA, Inc. in Manchester, N.H.

The overall thickness of bandaging expanse 20 herein is preferably about 0.5-inches.

Continuing with a structural description relating to bandaging expanse 20, and focusing attention for a moment on the graphical presentation of FIG. 3, this figure shows at 42, 44, 46, 48, 50, five different curves illustrating compressive-load versus compression-deflection behavioral characteristics, respectively, of previously-mentioned viscoelastic foam materials CF-47, CF-45, CF-42, CF-40, CF-NT. As can be seen, it is central curve 46 which illustrates specifically this behavior of the viscoelastic foam material, CF-42, which has been chosen preferably for employment in previously mentioned foam layer 30 in expanse 20.

What is made clearly evident by the curves presented in FIG. 3 is that, with respect to each of the five, different, viscoelastic foam materials whose characteristics are pictured in this figure, each of these material's so-pictured compressive-load versus compression-deflection characteristic exhibits a relatively large (long), linear region that extends generally between, and from, about 20% compression deflection to about 60% compression deflection. In this context, and with specific regard to the so-illustrated behavioral characteristic of preferred material CF-42 shown by curve 46, between these two, percentage, linear-range-defining conditions, a major percentage change of around 40% total compression-deflection differential is associated with what has been described above as an anatomically insignificant change in compressive load. More specifically, and focusing on the data presented in curve 46, the compressive-load change which accompanies this large (about 40%) percentage deflection change varies only from about 0.3- to about 0.7-psi.

Experience has shown that when bandaging expanse 20 is properly applied by one of skill in the art as a wrap around an anatomical limb, such as around the leg, with suitable wrapping tension introduced into this expanse, and accordingly, a suitable level of surface compression applied to the anatomy, the observed condition of foam layer 30 in the expanse is such that this foam layer exhibits, under those conditions, a compression deflection of around 35% to about 40%. This condition is observably achieved in normal use of the bandaging expanse proposed by the present invention when a person of ordinary skill in the medical arts applies the bandaging expanse with what might be thought of as an entirely normal wrap-tension force. Observation also clearly is that when this is done, the compressive load applied to the anatomy nominally lies about centrally in the linear range of the characteristic for the employed viscoelastic foam material, and specifically, for the preferred material CF-42, exists at about, or slightly less than, 0.5-pounds-per-square-inch, a compressive pressure which fully meets the important objective mentioned earlier herein of applying a compressive anatomical force which is above that expected for normal static fluid pressure in the anatomy, but below that which would cause undesirable venus-return blood flow.

As has been mentioned, bandaging expanse 20 is intended to be employed preferably as a wrap around a portion of the anatomy, such as an anatomical limb like the leg. Expanse 20, as illustrated in FIG. 1, is shown herein as a rectangle, but it need not necessarily have this particular perimetral shape. For example, the bandaging expanse structure may be formed in large sheets or rolls from which specific perimetrally outlined shapes may be cut for use. It may also be completely preformed in different shapes.

It turns out that a perimetral shape for expanse 20 which works quite well for bandaging a limb like the leg is a rectangle like that which is shown in FIG. 1. When this expanse is correctly applied as a wrap, as is generally illustrated in FIG. 5, it is applied in an edge-overlap wrap manner. Thus, in FIG. 5, such an edge-overlap condition is clearly pictured, with edge 20A overlapping edge 20B preferably by about three 2-3-inches.

While what may be thought of as a “full content”, dynamic-response bandaging system will include all three of the main components described hereinabove, it is entirely possible, in a systemic sense, to implement in accordance with the invention a partial-component bandaging system by using one of (a) the bandaging expanse alone, (b) the bandaging expanse along only with the tensioning structure, or (c) the bandaging expanse along only with the splinting structure.

Accordingly, where the bandaging expanse is used completely by itself, it, under those circumstances, may be thought of as constituting the invented bandaging system, and may be held in place, and applied under tension to produce compression in the surface of the anatomy, by a conventional overwrap of something like a traditional Acebandaging ribbon. Where the bandaging expanse is used only with the proposed tensioning structure, it is, of course, the tensioning structure which functions to introduce tension into the wrapped expanse, and compression into the surface of the anatomy (a preferable situation). Where the bandaging expanse is employed only with the proposed splinting structure, tension in the wrap, and compression in the surface of the anatomy, may be created by an Ace-bandage-ribbon overwrap.

Turning attention now to the construction of tensioning structure 26, and focusing specifically on FIGS. 4 and 5, this structure has an elongate, thin, rectangular configuration, as pictured in these two drawing figures. Structure 26 includes three subcomponents, or portions, namely, a pair of spaced, opposite-end, hook-and-pile, hook-portion, fabric end components 26a, 26b, made of the material sold under the above-referred-to trademark Velcro®, joined, as by stitching, to a central, elongate, elastomeric bridge 26c. Bridge 26c may be formed of any suitable elastomeric material, and preferably one which has an elongation capability of up to about 200%.

The special operational advantages of the three-component structure just described for each tensioning structure 26 were discussed earlier herein.

Referring now to splinting structure 24 as seen in FIGS. 7 and 8, the main element within this structure takes the form of a flexible splint body, such as the two splint bodies shown at 52, 54 in these two figures. Each of these bodies possesses a thin, planar, blade-like configuration, formed of a material such as conventional ABS plastic, or aluminum, with a thickness of approximately 0.125-inches. An appropriate aluminum is conventionally available type 6064T3 flat-bar aluminum. The splint bodies in splinting structure 26, as mentioned earlier, are referred to herein as being dynamic-response components on account of their springy flexibility.

It will be apparent to those skilled in the art that the exact perimetral dimensions and shapes of the proposed splint bodies may be defined differently in accordance with the anatomical regions where splinting is desired as a part of the bandaging system of the present invention. For example, for a leg-bandaging application, such as the one illustrated in FIGS. 9 and 10, elongate linear splint bodies with widths of about 2-3-inches, and lengths of about 12-inches or more may be employed. In the context of utilizing a splinting structure with a quite differently shaped splint body on a differently shaped bandaging expanse, and considering the ankle-and-foot-including bandaging and splinting application pictured in FIGS. 9 and 10, a somewhat right-angular splinting structure, such as that shown at 56 in FIG. 9, may be employed.

In accordance with the present invention, each splint body possesses what is referred to herein as an inner side and an outer side. For above-mentioned splint body 52, the inner side thereof is shown at 52a, and the outer side at 52b.

Affixed to the inner side of each splint body is a hook-portion fabric of conventional hook-and-pile fastening material. Such a hook-portion material affixed to splint body side 52a is shown generally at 58. Affixed to the outer side of each splint body is a pile-portion fabric of conventional hook-and-file fastening material, such as the pile-portion of this material shown at 60 affixed to splint body side 52b. These hook and pile-portions of hook-and-pile fastening material enable plural splinting bodies effectively to be joined releasably to one another in an infinite variety of ways to form a composite splinting structure such as the composite splinting structures that are specifically illustrated in FIGS. 7-10, inclusive.

A final point to be made with respect to the splint bodies that make up the individual splitting-structure components is that these thin, blade-like bodies are characterized each with a plurality, indeed almost an infinity, of preferential, in-plane bending axes, like the two axes which are shown, respectively, by a dash-dot line 62, and by a dash-double-dot line 64, in FIG. 7. It will be apparent to those skilled in the art, given the structural natures of the described splint bodies, that these preferential, in-plane bending axes may effectively lie substantially anywhere within the splint bodies, depending upon how a user of the splinting structure of this invention chooses to apply splinting structure in a bandaging operation, and also how, once bandaging has been installed, anatomical motion and other motion disturbances may cause flexurel/bending to occur.

From the various descriptions that have been given above regarding the several components which collectively make up the full dynamic-response bandaging system of the invention, it should be readily apparent how a bandaging operation, utilizing these components, may preferably be performed to create bandaging like that which is shown in FIGS. 9 and 10. For such an operation, one or more bandaging expanse(s), like expanse 20, appropriately shaped perimetrally is(are) wrapped to an edge-overlap condition, and then secured in place, and placed in tension to apply compression support to the wrapped anatomy, by use of a distribution, such as the distribution shown in FIGS. 9 and 10, of tensioning structures 26. If splinting is to take place, one or more of the hook-and-pile-equipped splint bodies is (are) applied easily and quickly both to one another, where composite splinting is required, and under all circumstances to the outer pile-portion surface of the applied bandaging expanse or expanses.

From the standpoint of the methodology which is proposed and offered by the present invention, and implemented at least in part by the several structural components discussed above, that methodology may be described as a dynamic-response anatomical bandaging method including (a) placing a dynamic-response, anatomical bandaging expanse as a wrap around a selected portion of an anatomical limb to form a wrapped portion of the limb, and (b) in relation to and as a consequence of such placing, applying, in accordance with self-compensating response occurring per se within the structure of the placed expanse, dynamically evenized wrap pressure to the wrapped portion of the limb, with such wrap pressure, under all dynamic circumstances with the expanse in place, exceeding that of static fluid pressure in the wrapped limb portion, but being less than that which would block venus-return blood flow in that limb portion.

In the practice of this methodology, the mentioned wrap pressure preferably lies in the range of about 0.3- to about 0.7-psi.

The proposed methodology further includes, before, and to accommodate, bandaging-expanse placing, providing a dynamic-response bandaging expanse which is characterized by including a dynamic-response, viscoelastic foam layer formed of a material which exhibits a compressive-load versus compression-deflection behavior characterized by a curve having a substantially linear region wherein a major change in compression deflection relates to an anatomically insignificant change in compressive load, with respect to which the mentioned anatomically insignificant change in compressive load relates to a wrap pressure lying in the above-referred-to range of about 0.3- to about 0.7-psi.

Accordingly, while a preferred and best-mode embodiment, and certain modifications thereof, of the structure and methodology of the present invention have been illustrated and described herein, we appreciate that other variations and modifications may be made by those skilled in the art which will come well within the scope and spirit of the present invention.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Migraine Headache Mitigation Invention Section:

We are uncertain about why the apparatus and methodology of the invention has the very positive, and quickly active, remedial effect which it appears to have, but invention-trial, private experiences with a number of people have who regularly endured migraine-headache events, using the apparatus, and applying the methodology, of the present invention, and doing so for only a moderate time period of about one hour or so, have reported significant reduction, even to the point of complete elimination, of migraine headache pain, with no return of that pain when practice of the methodology and use of the apparatus has ended following that time.

While, as just mentioned above, we do not know why the apparatus and methodology of the present invention provides, in the tested cases, relatively rapid and long-lasting relief from migraine headache pain, and while we understand that, notwithstanding our lack of understanding about the remediation process which takes place, it is very clear that it does, we do have some idea about what may be occurring.

More specifically, we think it is possible that pain associated with migraine headaches may have some form of relationship to the buildup and retention of anatomical static-fluid pressure which tends to create blood-flow blockage, and particularly venous-return blood-flow blockage, and thus an ischemic condition. The apparatus and methodology of the present invention is one wherein, specifically, yieldable pressure is applied all over and around the outside (top, sides and back) of the head at a pressure level which is specifically at least slightly below that pressure which can produce a blockage, or an occlusion of venous-return blood flow, but which is large enough to force an exit migration of static fluid. In this context, we have found, and we employ in the practice of this invention, a viscoelastic cushioning material which has a special compression, or applied-compression-producing-pressure (compressive-load), versus deflection (compressive-deflection) characteristic which exhibits a quite linear, plateau region, or condition, which is defined by a wide range of material deflections all of which are associated, i.e., throughout this range, with a nearly constant pressure that lies in a pressure range which turns out to encompass pressures that are, at the high end, slightly less than the pressure that would occlude anatomical venous-return blood flow, but which, at the low end, is greater than the pressure required to disperse anatomical static fluid. This very important pressure range extends from about 0.3- to about 0.7 -psi.

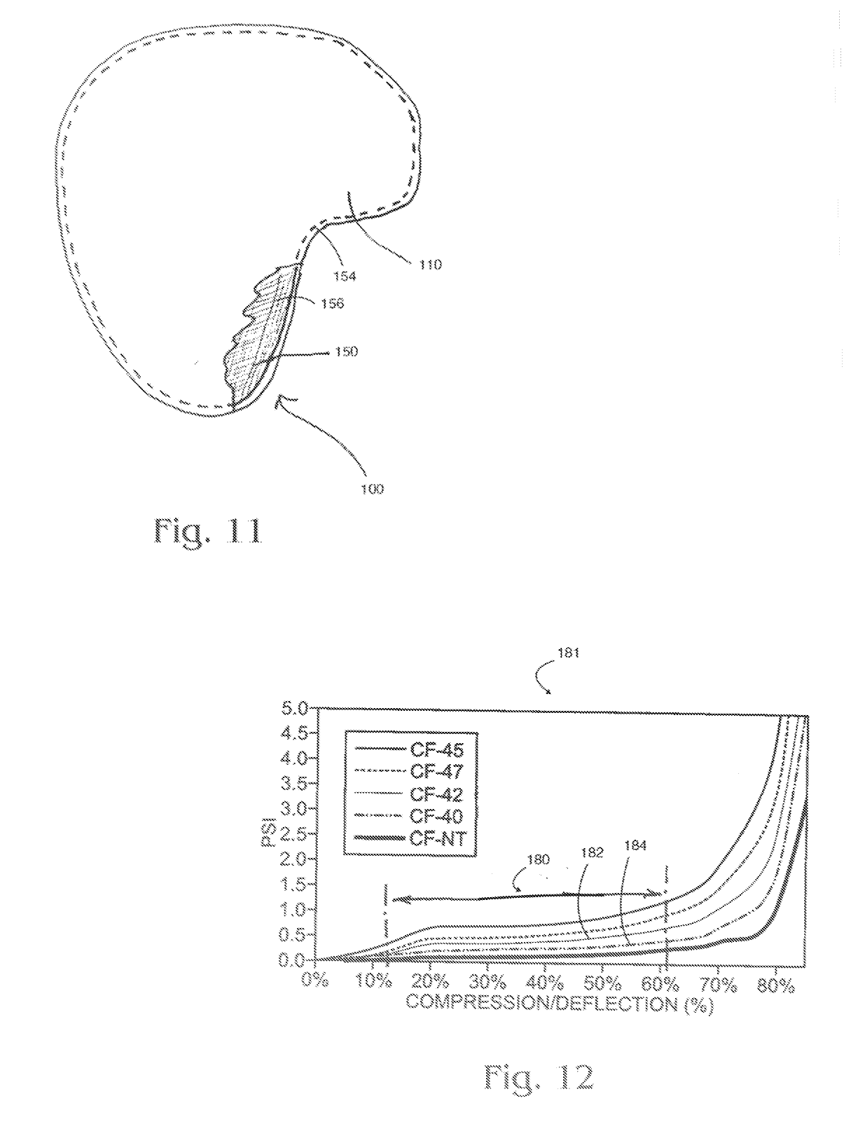

One example apparatus embodying the subject matter of this disclosure, apparatus 100, is illustrated in FIG. 11. Apparatus 100, as illustrated in FIG. 11, is relatively simple in construction, and includes, basically, two components taking the forms of (a) an outer, relatively rigid, broad and generally helmet-shaped, somewhat “bonnet-like” (but with no chinstrap) shell 110 which provides a compression reaction force for (b) an internal, substantially matching perimeter and also generally helmet-shaped, and somewhat “bonnet-like”, expanse 150 of viscoelastic cushioning material (preferably Confor-40 or Confor-42, and about ⅜- to about ⅝-inches thick) which we have just generally mentioned above. We think of this paired structure as being open and non-endless, in the sense that there is no loop of material which closes upon itself, or which is tightened in any way like a wrapper or a band. Rather, the combined outer shell and inner viscoelastic lining are simply fitted to the head under circumstances where a slight compression develops in the viscoelastic foam cushioning material to place this material in what was just described above as its characteristic “plateau” condition.

As FIG. 11 shows, shell 110 may be open and non-endless while being broad, generally helmet-shaped, and include a substantially rigid material. Shell 110 may provide a compression reaction force for expanse 150. As FIG. 11 illustrates, shell 110 may, in some examples, also be described as somewhat “bonnet-like,” though lacking, in this illustrated example, a chinstrap or other strap or fastening mechanism configured to tighten shell 110 around a user's head. Rather, shell 110 is fitted, along with expanse 150, to fit around a user's head without additional fastening means (though this disclosure understands that including such a fastening mechanism may be useful in some examples). In some examples, shell 110 may be made of a polycarbonate material.

As FIG. 11 shows, shell 110 may, in some examples, matchingly surround and contact allover expanse 150. In some examples, shell 110 may be configured to partially compress the compressible material in expanse 150.

As FIG. 11 illustrates, expanse 150 may define a lining within shell 110 that is similarly shaped but may define a slightly smaller perimeter (though this particular relative size between the two components is not specifically required). Expanse 150's position and shape when lining shell 110 is illustrated by expanse perimeter 154 of expanse 150. In some examples, expanses may define a viscoelastic foam material, such as Confor Foam #40 or Confor Foam #42. Additionally or alternatively, expanses may, in some examples, define a thickness lying in the rage of about ⅜ to about ⅝ inches. As FIG. 11 illustrates, expanse 150 may be fitted and positioned within shell 110 to contact the head of a wearer.

As FIG. 11 illustrates in a cutaway section, expanse 150 includes a compressible material 156. Compressible material 156 has a pressure-versus-deflection characteristic possessing a plateau condition, as illustrated by range 180 in graph 181 shown in FIG. 12. An example pressure-versus-deflection characteristic of Confor Foam #40 is illustrated in FIG. 12 by a CF-40 line 184, whereas an example pressure-versus-deflection characteristic of Confor Foam #42 is illustrated by a CF-42 line 182 in FIG. 12. FIG. 12 illustrates other example pressure-versus-deflection characteristics of other suitable expanse materials, such as Confor Foam #45, Confor Foam #47, and Confor Foam-NT.

In some examples, the plateau condition may be defined by a range of compressive material deflections associated throughout with a substantially constant material compression produced by an applied, material-compressing pressure which is slightly less than that pressure which, when applied to the anatomy, occludes anatomical, venous-return blood-flow. In some examples, the range of compressive material deflections associated throughout with a substantially constant material compression may be one which is produced by an applied, material-compressing pressure which, additionally, is greater than the pressure of static fluid within the anatomy. In some examples, the range of compressive material deflections associated throughout with a substantially constant material compression may be one which is produced by an applied, material-compressing pressure which lies within the range of about 0.3 psi to about 0.7 psi. This pressure may be applied, for example, by sizing shell 110 appropriately to place expanse 150 in its characteristic “plateau” condition of compression, as illustrated in FIG. 12. When in this plateau condition, expanse 150 may define a compression which defines, at every location, a non-adjustable value dependent entirely upon the fit-spacing at that location between a wearer's head and the inside of shell 110. As FIG. 11 illustrates, shell 110 may matchingly surround expanse 150, wherein shell 110 substantially contacts allover expanse 150.

This arrangement is distinguished from what is illustrated and described in the above-mentioned, background regular patent application wherein compression in a viscoelastic cushioning material is developed by closing a loop of that material, and employing an external wrapper, or other closure structure which is placed in tension. Such a closed “loop” arrangement is inapplicable in the setting for which the present invention is designed. Open-structure compression in relation to use of the present invention is developed simply by proper-size fitment of the apparatus of the invention on a wearer's head.

While we certainly recognizes that human head sizes vary quite a bit, what we have learned is that the apparatus of the invention may be, fundamentally, be provided in basically three different general sizes, referred to as small, medium, and large, from which an appropriate size can almost always be drawn which will appropriately fit a wearer's head under circumstances producing the desired “plateau-range” compression described herein.

In addition to the discussed apparatuses, this disclosure equally considers non-medication, analgesic method for reducing migraine headache pain using said apparatuses. For example, some methods may include fitting, to a wearer's head, for an appropriate time expanse, disclosed apparatuses or other similar apparatuses for reducing migraine headache pain. In addition, this disclosure considers additional or alternative non-medication, analgesic methods for reducing migraine headache pain including, for an appropriate time expanse, applying to a helmet-shaped region of a wearer's head a pressure throughout that region which lies in a range wherein the applied pressure is greater than the pressure of static fluid within the anatomy, and less than the pressure which, when applied to the anatomy, occludes anatomical, venous-return blood flow.

Figures accompanying this disclosure of the present invention include FIG. 11, just very generally, and in side outline with a portion broken away, illustrates the helmet-shaped components that make up the apparatus of the invention, and the other of which, FIG. 2, generally illustrates the compressive force versus deflection “plateau characteristic” mentioned for the desired viscoelastic cushioning material.

Characterizations of the Invention:

A0. Apparatus for reducing migraine headache pain including an open and non-endless, broad, generally helmet-shaped, head-contacting expanse of compressible material having a pressure-versus-deflection characteristic possessing a plateau condition defined by a range of compressive material deflections associated throughout with a substantially constant material compression produced by an applied, material-compressing pressure which is slightly less than that pressure which, when applied to the anatomy, occludes anatomical, venous-return blood flow, and an open and non-endless, broad and also generally helmet-shaped, rigid-material reaction shell substantially matchingly surrounding, and contacting allover, the compressible-material expanse, appropriately sized, and operable, with the apparatus in place on a wearer's head, to place the compressible material in the expanse in its characteristic “plateau” condition of compression, wherein such compression, at every location, is a non-adjustable value dependent entirely upon the fit-spacing at that location between a wearer's head and the inside of the shell.

A1. The apparatus of characterization A0, wherein the range of compressive material deflections associated throughout with a substantially constant material compression is one which is produced by an applied, material-compressing pressure which, additionally, is greater than the pressure of static fluid within the anatomy.

A2. The apparatus of characterization A0, wherein the range of compressive material deflections associated throughout with a substantially constant material compression is one which is produced by an applied, material-compressing pressure which lies within the range of about 0.3- to about 0.7-psi.

A3. The apparatus of characterization A0, wherein the compressible-material expanse is formed of a viscoelastic foam material.

A4. The apparatus of characterization A3, wherein the viscoelastic foam material takes the form of Confor Foam #40 or Confor Foam #42 with a thickness lying in the range, preferably but not necessarily, of about ⅜- to about ⅝-inches.

A5. The apparatus of characterization A0, wherein the shell is formed of a polycarbonate material.

B0. A non-medication, analgesic method for reducing migraine headache pain including fitting to a wearer's head, for an appropriate time expanse, the interactive and cooperative combination of (a) an open and non-endless, broad, generally helmet-shaped, head-contacting expanse of compressible material having a pressure-versus-deflection characteristic possessing a plateau condition defined by a range of compressive material deflections associated throughout with a substantially constant material compression produced by an applied, material-compressing pressure which is slightly less than that pressure which, when applied to the anatomy, occludes anatomical, venous-return blood flow, and (b) an appropriately sized, open and non-endless, broad and also generally helmet-shaped, rigid-material reaction shell substantially matchingly surrounding, and contacting allover, the compressible-material expanse, and following such fitting, employing the fitted apparatus to place the compressible material in the expanse in its characteristic “plateau” condition of compression relative to the wearer's head, wherein such compression, at every location, is a non-adjustable value dependent entirely upon the fit-spacing at that location between the wearer's head and the inside of the shell.

B1. The method of characterization B0, wherein the range of compressive material deflections associated throughout with a substantially constant material compression is one which is produced by an applied, material-compressing pressure which, additionally, is greater than the pressure of static fluid within the anatomy.

B2. The method of characterization B0, wherein the range of compressive material deflections associated throughout with a substantially constant material compression is one which is produced by an applied, material-compressing pressure which lies within the range of about 0.3- to about 0.7-psi.

C0. A non-medication, analgesic method for reducing migraine headache pain including, for an appropriate time expanse, applying to an open and non-endless, helmet-shaped, outside region of a wearer's head a pressure throughout that region which lies in a range wherein the applied pressure is greater than the pressure of static fluid within the anatomy, and less than that pressure which, when applied to the anatomy, occludes anatomical, venous-return blood flow.

C1. The method of characterization CO, wherein the applied-pressure range is defined between about 0.3- and about 0.7-psi.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. Apparatus for reducing migraine headache pain comprising:
an open and non-endless, broad, generally helmet-shaped, head-contacting expanse of compressible material having a pressure-versus-deflection characteristic possessing a plateau condition defined by a range of compressive material deflections associated throughout with a substantially constant material compression produced by an applied, material-compressing pressure which is slightly less than that pressure which, when applied to the anatomy, occludes anatomical, venous-return blood flow, and
an open and non-endless, broad and also generally helmet-shaped, rigid-material reaction shell substantially matchingly surrounding, and contacting allover, the compressible-material expanse, appropriately sized, and operable, with the apparatus in place on a wearer's head, to place the compressible material in the expanse in its characteristic “plateau” condition of compression, wherein such compression, at every location, is a non-adjustable value dependent entirely upon the fit-spacing at that location between a wearer's head and the inside of the shell.

2. The apparatus of claim 1, wherein the range of compressive material deflections associated throughout with a substantially constant material compression is one which is produced by an applied, material-compressing pressure which, additionally, is greater than the pressure of static fluid within the anatomy.

3. The apparatus of claim 1, wherein the range of compressive material deflections associated throughout with a substantially constant material compression is one which is produced by an applied, material-compressing pressure which lies within the range of about 0.3- to about 0.7-psi.

4. The apparatus of claim 1, wherein the compressible-material expanse is formed of a viscoelastic foam material.

5. The apparatus of claim 4, wherein the viscoelastic foam material takes the form of Confor Foam #40 or Confor Foam #42 with a thickness lying in the range, preferably but not necessarily, of about ⅜- to about ⅝-inches.

6. The apparatus of claim 1, wherein the shell is formed of a polycarbonate material.

7. A non-medication, analgesic method for reducing migraine headache pain including fitting to a wearer's head, for an appropriate time expanse, an interactive and cooperative combination of (a) an open and non-endless, broad, generally helmet-shaped, head-contacting expanse of compressible material having a pressure-versus-deflection characteristic possessing a plateau condition defined by a range of compressive material deflections associated throughout with a substantially constant material compression produced by an applied, material-compressing pressure which is slightly less than that pressure which, when applied to the anatomy, occludes anatomical, venous-return blood flow, and (b) an appropriately sized, open and non-endless, broad and also generally helmet-shaped, rigid-material reaction shell substantially matchingly surrounding, and contacting allover, the compressible-material expanse, and following such fitting, employing the fitted apparatus to place the compressible material in the expanse in its characteristic “plateau” condition of compression relative to the wearer's head, wherein such compression, at every location, is a non-adjustable value dependent entirely upon the fit-spacing at that location between the wearer's head and the inside of the shell.

8. The method of claim 7, wherein the range of compressive material deflections associated throughout with a substantially constant material compression is one which is produced by an applied, material-compressing pressure which, additionally, is greater than the pressure of static fluid within the anatomy.

9. The method of claim 7, wherein the range of compressive material deflections associated throughout with a substantially constant material compression is one which is produced by an applied, material-compressing pressure which lies within the range of about 0.3- to about 0.7-psi.

10. A non-medication, analgesic method for reducing migraine headache pain including, for an appropriate time expanse, applying to an open and non-endless, helmet-shaped, outside region of a wearer's head a pressure throughout that region which lies in a range wherein the applied pressure is greater than the pressure of static fluid within the anatomy, and less than that pressure which, when applied to the anatomy, occludes anatomical, venous-return blood flow.

11. The method of claim 10, wherein the applied-pressure range is defined between about 0.3- and about 0.7-psi.
